(19) United States
(12) Patent Application Publication
(10) Pub. No.: US 2022/0095717 A1
(43) Pub. Date: Mar. 31, 2022

(54) ISOLATOR DEVICE FOR MEDICAL USE

(71) Applicant: Oxti Corporation, Taipei (TW)

(72) Inventor: Chih Feng HO, Taipei (TW)

(21) Appl. No.: 17/034,967

(22) Filed: Sep. 28, 2020

(51) Int. Cl. A41D 13/11; A41D 27/12; A62B 18/04; A42B 3/30

(52) U.S. Cl. CPC A41D 13/1153; A41D 13/1161; A41D 2300/20; A62B 18/045; A42B 3/30; A41D 27/12

(57) ABSTRACT

An isolator device includes a housing for engaging with a head of a user and a nasal mask for covering a nose of the user, a filter member attached to the housing for dirt filtering purposes, a radio attached to the housing, a speaker attached to the housing and connected to the radio for allowing a sound generated by the user to be amplified and to be heard by people, and an earpiece attached to the housing and connected to the radio for allowing an external sound to be amplified and to be heard by the user. The radio is selected from a two-way radio. A fan member is attached to the housing for circulating an air into the chamber of the housing.

### BACKGROUND OF THE INVENTION

### 1. Field of the Invention

The present invention relates to an isolator device for medical use, and more particularly to an isolator device including an improved structure or configuration for being easily and quickly and readily attached or mounted or secured or engaged onto the face or the head of the user and for preventing the user or people from been contaminated by the epidemic infectious diseases or the like, and for allowing the user to be easily and quickly and readily communicated with the other people.

### 2. Description of the Prior Art

Various kinds of epidemic infectious diseases have been widely spread and infected throughout the world recently, such as the avian influenza, the new influenza, the influenza a virus subtype H1N1, the severe acute respiratory syndrome (SARS), the coronavirus disease 2019 COVID-19), etc., and people should wear a mask or hood for preventing the user or people. from been contaminated by the epidemic infectious diseases or the like.

Normally, the mask or hood may only be attached or mounted or secured or engaged onto the face or the head of the user for covering or shielding the nose and the mouth of the user and for preventing the user or people from been contaminated by the epidemic infectious diseases or the like.

However, the typical masks or hoods have no air circulating structure or configuration such that the user or people may feel uncomfortable after use, particularly the user or people may wear the typical masks or hoods all day long.

For example, U.S. Pat. No. 6,698,427 B1 to Clowers, U.S. Pat. No. 6,988,500 B1 to Cox, U.S. Pat. No. 7,992,558 B2 to Thornton et al., U.S. Pat. No. 8,020,276 B2 to Thornton, and U.S. Pat. No. 9,132,251 B2 to Johansen disclose several of the typical masks or hoods each comprising a mask body for attaching or mounting or securing or engaging onto the face or the head of the user.

However, while wearing the typical masks or hoods, the user may not breathe well and may not feel comfortable after use, particularly the user or people may be required to wear the typical masks or hoods all day long.

The present invention has arisen to mitigate and/or obviate the afore-described disadvantages of the conventional masks or isolator devices.

### SUMMARY OF THE INVENTION

The primary objective of the present invention is to provide an isolator device for medical use including an improved structure or configuration for being easily and quickly and readily attached or mounted or secured or engaged onto the face or the head of the user and for preventing the user or people from been contaminated by the epidemic infectious diseases or the like, and for allowing the user to be easily and quickly and readily communicated with the other people.

In accordance with one aspect of the invention, there is provided an isolator device comprising a housing including a chamber formed in the housing for engaging with a head of a user, the housing including a nasal mask attached to the housing for covering and shielding a nose of the user, a filter member attached to the housing for dirt filtering purposes, a radio attached to the housing, a speaker attached to the housing and connected to the radio for allowing a sound generated by the user to be amplified and to be heard by people, and an earpiece attached to the housing and connected to the radio for allowing an external sound to be amplified and to be heard by the user.

The housing includes a fastening member attached to the housing, and the filter member includes a fastening element engageable with the fastening member for detachably securing the filter member to the housing. The radio is selected from a two-way radio.

The housing includes a fan member attached to the housing for circulating an air into the chamber of the housing and for allowing the user to breathe the fresh air. The housing includes a filter element attached to the housing and engaged between the housing and the fan member for dirt filtering purposes.

The housing includes a peripheral member attached to a lower portion of the housing for engaging with a neck portion of the user for preventing the dirt and viruses from entering into the chamber of the housing through the lower or bottom portion of the housing. The housing includes a cover engaged in the chamber and in a rear portion of the housing and rotatably coupled to the housing with a pivot axle for allowing the cover to be rotated relative to the housing.

The housing further includes a hood engaged in the chamber and in the rear portion of the housing and rotatably coupled to the housing with the pivot axle for allowing the hood to be rotated relative to the cover and the housing. The housing includes an earphone attached to the cover and connected to the radio for allowing the external sound to be amplified and to be heard by the user.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a side plan schematic view of an isolator device in accordance with the present invention;

FIG. 2 is a side plan and partial exploded view of the isolator device;

FIGS. 3, 4, 5 are side plan schematic views similar to FIG. 1, illustrating the operation of the isolator device;

FIG. 6 is a bottom plan schematic view of the isolator device; and

FIG. 7 is a block diagram illustrating the parts or elements of the isolator device.

### DETAILED DESCRIPTION OF THE PREFERRED EMBODIMENT

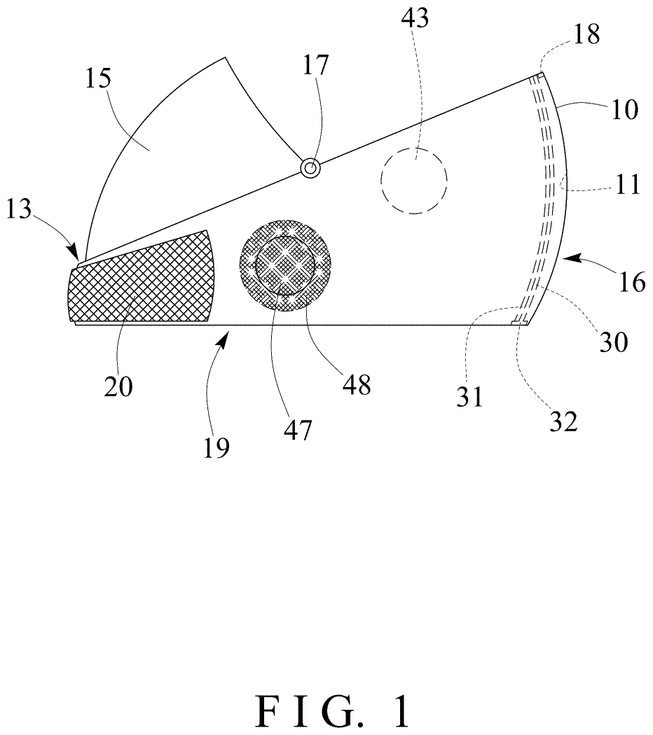

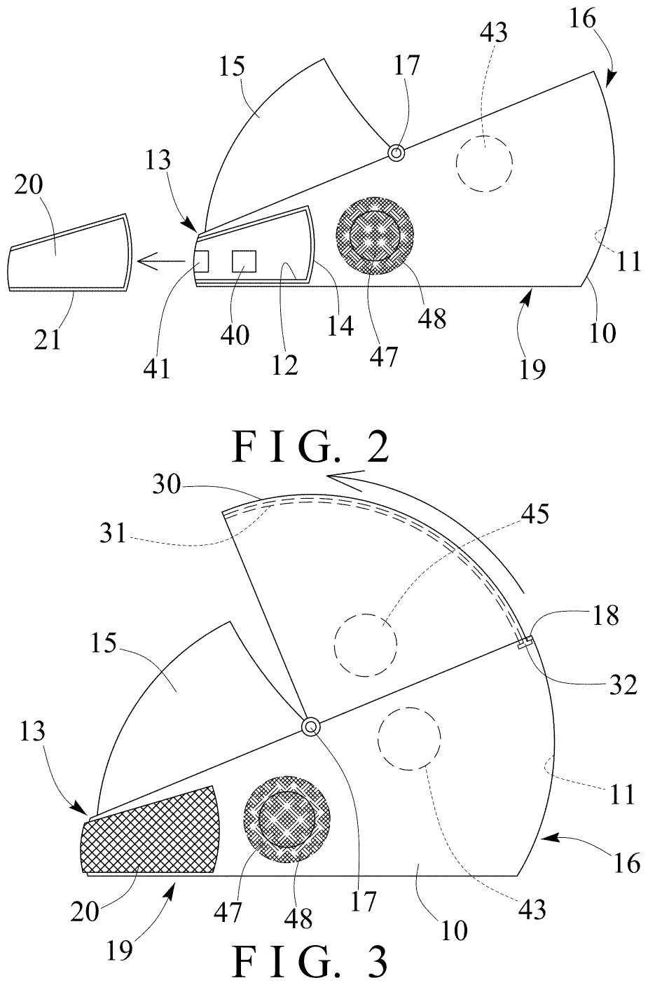

Referring to the drawings, and initially to FIGS. 1-2, an isolator device in accordance with the present invention comprises a mask body or housing 10 including a compartment or chamber 11 formed therein for receiving or engaging with the head of the user and for allowing the housing 10 to be engaged onto the face or the head of the user, the housing 10 includes an opening 12 or a porous structure or configuration formed or provided in the front portion 13 of the housing 10, and a catch or latch or welder or adhesive material or fastening member 14, such as a hook and loop member 14 or the like attached or mounted or secured or engaged onto the front portion 13 of the housing 10 for attaching or mounting or securing or engaging with a filter layer or member 20.

For example, the filter layer or member 20 also includes a catch or latch or welder or adhesive material or fastening element 21, such as a hook and loop element 21 or the like formed or provided thereon for engaging with the fastening member 14 and for detachably or changeably or removably attaching or mounting or securing the filter member 20 onto the front portion 13 of the housing 10 and for covering or shielding the porous structure or the opening 12 of the housing 10 and for dirt and viruses filtering purposes. The housing 10 further includes a nasal mask 15 attached or mounted or secured or engaged onto the front portion 13 of the housing 10 for engaging with and/or for covering or shielding the nose of the user.

An outer shield or cover 30 and an inner shield or hood 31 are received or engaged in the chamber 11, such as at the rear portion 16 of the housing 10, and pivotally or rotatably connected or coupled to the housing 10 with a pivot shaft or axle 17 for allowing the cover 30 and the hood 31 to be pivoted or rotated relative to the housing 10, and to be unfolded or opened to the upwardly and outwardly open position (FIGS. 3-5) and for covering or shielding the head of the user. The cover 30 includes a catch or latch 32 (FIGS. 1, 3) formed or provided on the lower or bottom portion thereof for engaging with another catch or latch or stop 18 which is formed or provided in the rear portion 16 of the housing 10 and for guiding and limiting the cover 30 to pivot or rotate relative to the housing 10.

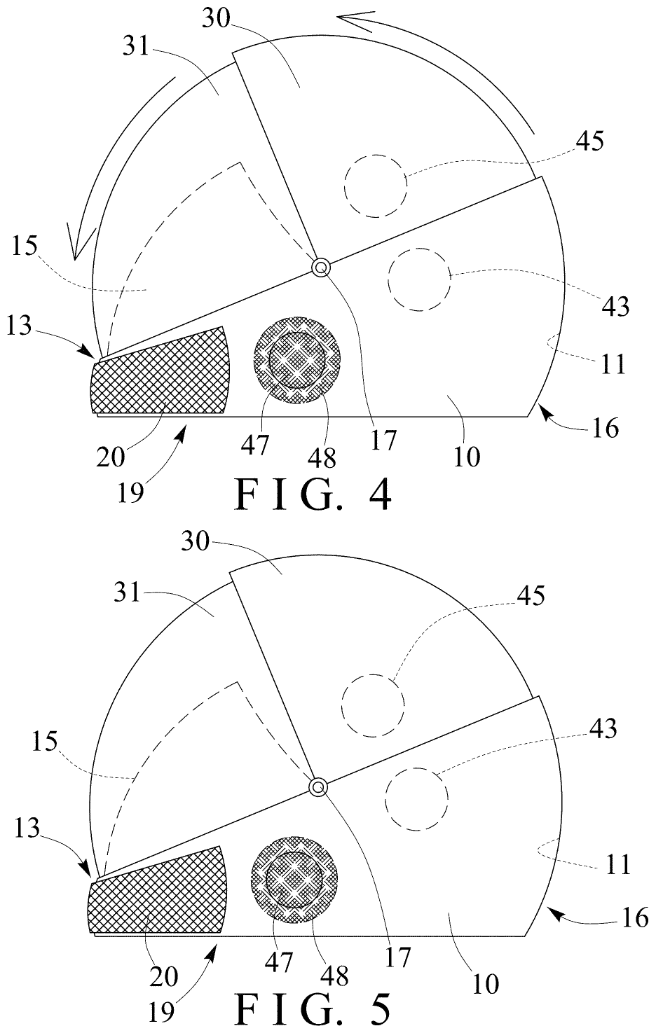

As shown in FIGS. 4 and 5, the hood 31 may further be pivoted or rotated or unfolded or opened outwardly relative to the cover 30 for covering or shielding the front portion of the user and also for covering or shielding the nasal mask 15 of the housing 10. It is preferable that the housing 10 further includes a peripheral flap or flange or member 23 (FIG. 6) attached or mounted or secured to the lower or bottom portion 19 of the housing 10 for engaging with the neck portion of the user and for preventing the dirt and viruses from entering into the chamber 11 of the housing 10 through the lower or bottom portion 19 of the housing 10.

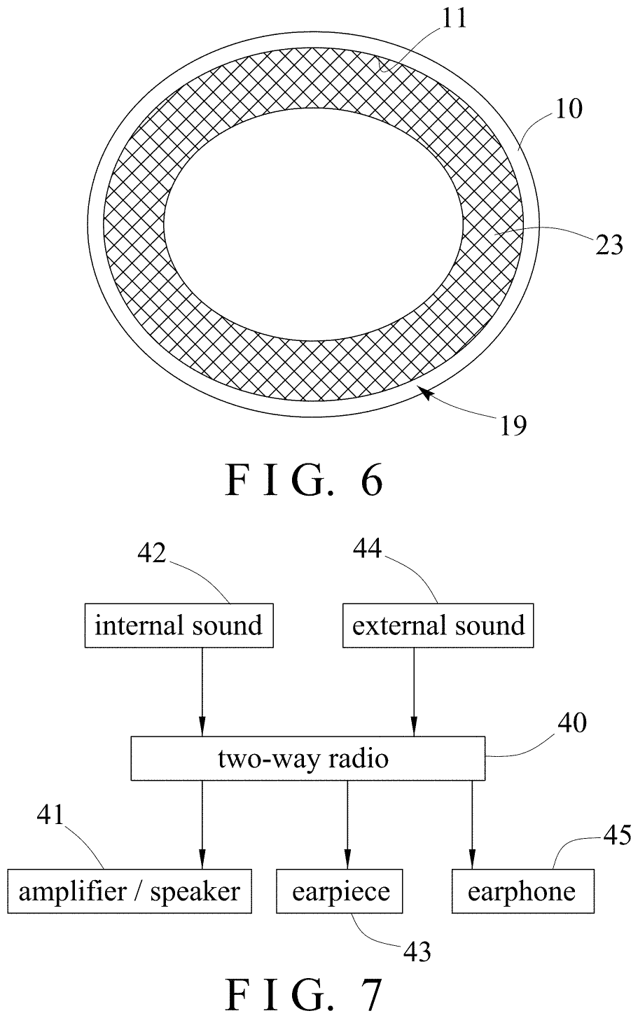

As shown in FIGS. 2 and 7, a radio 40, such as a two-way radio 40 is attached or mounted or secured to the housing 10, such as at the front portion 13 of the housing 10, and an amplifier or speaker 41 is attached or mounted or secured to the housing 10, also at the front portion 13 of the housing 10, and electrically connected or coupled to the two-way radio 40 for allowing the internal sound 42 (FIG. 7) generated by the user to be amplified and to be heard by people, and a headset or headphone or earphone or earpiece 43 may further be provided and attached or mounted or secured to the housing 10, such as at the rear portion 16 of the housing 10 and electrically connected or coupled to the two-way radio 40 for allowing the external sound 44 (FIG. 7) to be amplified and to be heard by the user.

As shown in FIGS. 3-5, another headset or headphone or earpiece or earphone 45 may further be provided and attached or mounted or secured to the cover 30 and electrically connected or coupled to the two-way radio 40 for allowing the external sound 44 (FIG. 7) to be amplified and to be heard by the user. As shown in FIGS. 1-5, a fan device or member 47 may further be provided and attached or mounted or secured to the housing 10 for drawing or circulating the air into the chamber 11 of the housing 10, and another filter layer or element 48 may further be provided and attached or mounted or secured to the housing 10 may further be provided and attached or mounted or secured to the housing 10 and engaged between the housing 10 and the fan member 47 for dirt and viruses filtering purposes.

In operation, as shown in FIGS. 1 and 2, the housing 10 may be engaged onto the face or the head of the user, and the peripheral member 23 (FIG. 6) may be engaged with the neck portion of the user for preventing the dirt and viruses from entering into the chamber 11 of the housing 10 through the lower or bottom portion 19 of the housing 10. The nasal mask 15 may engage with and may cover or shield the nose of the user. The fan member 47 may circulate the air into the chamber 11 of the housing 10 for allowing the user to breathe the fresh air. The amplifier or speaker 41 allows the internal sound 42 (FIG. 7) generated by the user to be amplified and to be heard by people, and the earpiece 43 and/or the earphone 45 allows the external sound 44 (FIG. 7) to be amplified and to be heard by the user.

As shown in FIGS. 3-5, the cover 30 and/or the hood 31 may further be pivoted or rotated relative to the housing 10 outwardly to the upwardly and outwardly unfolded or opened position for suitably covering or shielding the head of the user when required or when necessary.

Accordingly, the isolator device for medical use in accordance with the present invention includes an improved structure or configuration for being easily and quickly and readily attached or mounted or secured or engaged onto the face or the head of the user and for preventing the user or people from been contaminated by the epidemic infectious diseases or the like, and for allowing the user to be easily and quickly and readily communicated with the other people.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An isolator device comprising:
a housing including a chamber formed in said housing for engaging with a head of a user, said housing including a nasal mask attached to said housing for covering and shielding a nose of the user,
a filter member attached to said housing for dirt filtering purposes,
a radio attached to said housing,
a speaker attached to said housing and connected to said radio for allowing a sound generated by the user to be amplified and to be heard by people, and
an earpiece attached to said housing and connected to said radio for allowing an external sound to be amplified and to be heard by the user.

2. The isolator device as claimed in claim 1, wherein said housing includes a fastening member attached to said housing, and said filter member includes a fastening element engageable with said fastening member for detachably securing said filter member to said housing.

3. The isolator device as claimed in claim 1, wherein said radio is selected from a two-way radio.

4. The isolator device as claimed in claim 1, wherein said housing includes a fan member attached to said housing for circulating an air into said chamber of said housing.

5. The isolator device as claimed in claim 4, wherein said housing includes a filter element attached to said housing and engaged between said housing and said fan member for dirt filtering purposes.

6. The isolator device as claimed in claim 1, wherein said housing includes a peripheral member attached to a lower portion of said housing for engaging with a neck portion of the user.

7. The isolator device as claimed in claim 1, wherein said housing includes a cover engaged in said chamber and in a rear portion of said housing and rotatably coupled to said housing with a pivot axle for allowing said cover to be rotated relative to said housing.

8. The isolator device as claimed in claim 7, wherein said housing includes a hood engaged in said chamber and in the rear portion of said housing and rotatably coupled to said housing with said pivot axle for allowing said hood to be rotated relative to said cover and said housing.

9. The isolator device as claimed in claim 7, wherein said housing includes an earphone attached to said cover and connected to said radio for allowing the external sound to be amplified and to be heard by the user.
